(19) United States
(12) Patent Application Publication
(10) Pub. No.: US 2015/0373672 A1
(43) Pub. Date: Dec. 24, 2015

(54) METHOD AND NETWORK ELEMENT FOR MANAGING BACKHAUL RESOURCES

(71) Applicant: NOKIA SOLUTIONS AND NETWORKS OY, Espoo (FI)

(72) Inventor: Mika FORSSELL, Tolkkinen (FI)

(21) Appl. No.: 14/766,229

(22) PCT Filed: Feb. 13, 2013
(86) PCT No.: PCT/EP2013/052848

§ 371 Date: Aug. 6, 2015

(51) Int. Cl. H04W 72/04; H04W 28/20

(52) U.S. Cl. CPC H04W 72/04; H04W 28/20; H04W 88/10

(57) ABSTRACT

It is provided a method for managing backhaul resources, comprising accessing a radio network via a first radio technology 401 and providing first backhaul resources 404 allocated to the first radio technology 401. Moreover the method may comprise accessing the radio network via a second radio technology 402 and providing second backhaul resources 405 allocated to the second radio technology 402, wherein the second radio technology is based on Wi-Fi technology. Moreover, the method may comprise sharing the first backhaul resources 404 and the second backhaul resources 405 as common backhaul resources 408, detecting a criteria for triggering a backhaul resource management; and managing the common backhaul resources 408 by adapting the allocation for at least one of the first radio technology or the second radio technology.

### BACKGROUND

The invention relates to communication networks. Embodiments of the present invention relate generally to mobile communications and more particularly to network devices and methods in communication networks. In particular, the invention relates to a method, to a network device and to a network system for managing backhaul resources in a communication network. Furthermore, the present invention relates to a computer program product and a computer-readable medium.

A heterogeneous network (HetNet) technology may comprise a use of multiple types of access nodes in a wireless network. A Wide Area Network may use macrocells, picocells, and/or femtocells in order to offer wireless coverage in an environment with a wide variety of wireless coverage zones, ranging from an open outdoor environment to office buildings, homes, and underground areas. In this content a HetNet may be understood as different radio access technologies (RATs) using different frequency bands located on the same geographical area. These access technologies may include 2G, 3G. LTE, LTE-A (LTE-Advanced), Wi-Fi plus their respective frequency bands. This may create a need to control how UEs utilize different RATs, frequency bands and network resources related to these.

Mobile data traffic volumes are growing rapidly and several operators of communication networks are planning to use (stand alone) Wi-Fi for additional wireless coverage and capacity. This is planned for both indoor use and outdoor use. In addition, operators are planning to deploy small cells solutions where cellular LTE and/or 3G is provided by a small cell base station serving limited coverage area, and optionally integrating also Wi-Fi AP into the base station.

In addition to small cell technology and Wi-Fi technology, several operators have started to require Hetnet traffic steering solutions where user experience and network resource utilization should be balanced.

There may be a need to provide a technology for resource management in the backhaul of a communication network.

### EXEMPLARY EMBODIMENTS OF THE PRESENT INVENTION

According to an exemplary embodiment of the present invention there is provided a method for managing backhaul resources. The method may comprise accessing a radio network via a first radio technology and providing first backhaul resources allocated to the first radio technology. The method may further comprise accessing the radio network via a second radio technology and providing second backhaul resources allocated to the second radio technology, wherein the second radio technology is based on Wi-Fi technology. Moreover, the method may comprise sharing the first backhaul resources and the second backhaul resources as common backhaul resources and detecting a criteria for triggering a backhaul resource management between the first and second backhaul resources. Furthermore the method may comprise managing the common backhaul resources by adapting the allocation for at least one of the first radio technology or the second radio technology.

In addition there may be provided a network element for managing backhaul resources comprising an entity for observing accessing a radio network via a first radio technology and for observing first backhaul resources allocated to the first radio technology. Moreover, the network element may comprise an entity for observing accessing the radio network via a second radio technology and observing second backhaul resources allocated to the second radio technology, wherein the second radio technology may be based on Wi-Fi technology. Furthermore the network element may comprise an entity for observing a sharing of the first backhaul resources and the second backhaul resources as common backhaul resources, an entity for detecting a criteria for triggering a backhaul resource management, and an entity for managing the common backhaul resources by adapting the allocation for at least one of the first radio technology or the second radio technology.

There may be provided a solution for managing backhaul resources for one or several base stations or for one or more small cell base stations or a combination thereof. It is assumed that backhaul resources are shared between multiple radio access technologies (RAT), at least two RATs, provided by one several base stations. These radio technologies may include for example 2G, 3G, LTE, LTE-Advanced, Wi-Fi radio access technology, wherein at least one technology based on Wi-Fi is involved and provided by one base station or one small cell base station. It should be noted that a small cells base station is one example of a specific base station, whereas any base station with two or more RATs may be covered by the provided solution. The provided solution may also apply to cases where more than one base station (including one or more RATs) share the same backhaul resources.

It may be foreseen that the first radio technology is provided by a first wireless base station and the second radio technology is provided by a second wireless base station, wherein the first wireless base station and the second wireless base station are part of a small cells base station.

According to an exemplary embodiment of the present invention managing the common backhaul resources may be provided by adjusting bandwidth within the common backhaul resources.

According to an exemplary embodiment of the present invention the method may further comprise managing the common backhaul resources by allocating at least one service requested by the first radio technology or by the second radio technology to another radio technology, which radio technology was not accessed initially for that service.

Such a service is for example a video or browsing in the internet.

Moreover, it may be foreseen that a criteria for triggering a backhaul resource management may be at least one criteria selected of the group consisting of a radio technology used as first radio technology, a radio technology used as a second radio technology, a congestion situation, bandwidth required for a radio technology, importance of users using a radio technology, priority of users using a radio technology, Quality of Service (QoS) associated to users using a radio technology, QoS associated to applications using a radio technology, data indicating quality of a user experience, data indicating network performance (such as network element or network interface resource utilization), applications/services used in a radio technology, network element operability status (e.g. broken LTE base station leads to deactivating backhaul resources related to the base station and sharing the resources to other network elements), kind of user category and performance situation of a radio technology.

The managing of backhaul resources may be provided according to one or a plurality of criteria, for example a usage of the radio resources of the base station/small cell base station. Moreover, managing the common backhaul resources may be based on further criteria, such as a radio usage of a base station, a kind of base station technology, an importance of a user, a priority of users accessing a base station, a network performance related to users accessing a base station, an identity associated to user or service on backhaul like a virtual LAN identity (VLAN id), an SSID activation or an SSID deactivation.

For example if LTE is used heavily while Wi-Fi radio is used less, more backhaul resources can be allocated for the LTE RAT. In addition an operator may have transport network integrating N×backhauls of base stations and then the shared medium resources and bandwidth could be managed according to usage of each base station. Low usage of a base station may lead to narrow bandwidth allocation for the first base station and thus more bandwidth/resources may be shared among the other base stations sharing the transport medium/backhaul. When usage of the first base station increases, bandwidth/resource allocation of backhaul associated to the first base station may increase as well that may lead to reduction of bandwidth/resource allocation of backhaul related to another base station.

In a base station/a small cell base station having two or more RATs (like LTE and Wi-Fi), a HRM (Hetnet Resource Manager) within the small cells may control backhaul resources allocated to LTE and Wi-Fi, for example based on radio utilization of the RATs, user priority using the RATs to ensure service quality for important users, QoS etc. The HRM may trigger modifications on backhaul characteristics, like allocated bandwidth and/or QoS, according to need. One HRM characteristics may be awareness of radio resources and managing radio resources.

Therefore a HRM may be located in eNB/RNC or some other network element in case of “centralized radio resource management”. Moreover, the HRM may trigger backhaul resource management actions related to e.g. backhaul of a small cell base station.

In case N×base station backhauls are integrated into a shared transport medium, a backhaul resource manager (BRM) may control backhaul resource allocation for different base stations and other components connected to the backhaul. The BRM may be located in a base station or in a separate component, like a Border Network Gateway (BNG), a Broadband Remote Access Server (BRAS), a Security Gateway (Security GW), or separate network element connected to the backhaul, BRM and HRM may also be the same functional entity. The BRM may for example monitor traffic amounts or signaling related to different base stations to determine backhaul resource allocations. For example the BRM may monitor RRC messages to determine radio resource allocations related to different base stations. The BRM may also be the end point element terminating base station backhauls (like Security GW containing BRM functionality) and negotiating resources for each backhaul with HRMS of the base stations. A BRM may be understood as a backhaul resource management control point, which may be aware of multiple backhauls connected to multiple base stations/APs. A HRM may act more AP/base station specific and may manage resources associated to multiple base stations/APs. The HRM may be a local entity and may manage e.g. LTE/Wi-Fi backhaul belonging to the same base station. However, both HRM and BRM may be present within one single network element.

Small cells may be understood as low-powered radio access nodes that operate in licensed and unlicensed spectrum, which may have a range of ten meters up to several hundreds of meters, compared to a mobile macrocell which may have a range of a few kilometers. With mobile operators struggling to support the growth in mobile data traffic, many are using Mobile data offloading as a more efficient use of radio spectrum. Small cells may be present as an element to 3G data off-loading. Furthermore, Small cells may encompass femtocells, picocells, and microcells. Small-cell networks can also be realized by means of distributed radio technology consisting of centralised baseband units and remote radio heads. Small cells may operate in a wide range of air interfaces including GSM, CDMA2000, TD-SCDMA, W-CDMA, LTE, Wi-Fi and WiMax. In 3GPP terminology, a Home Node B (HNB) may be a 3G femtocell and a Home eNode B (HeNB) may be an LTE femtocell. A small cell base station may be understood as a base station installed in a small cell for serving users in this cell by providing radio access for these users.

With the following exemplary features backhaul resources may be managed:
a. The approach may not necessarily apply to only small cells integrating two or more RATs (3G, LTE, Wi-Fi) but may apply also to any wireless base station wherein backhaul uses a shared medium with other base stations. For example heavy use of LTE small cell base station results into less backhaul resource allocation of lightly used LTE macro base station.
b. Another approach may relate to dynamic backhaul resource management based on any one of the following criteria:
   radio usage of base stations and base station technologies (3G, LTE, Wi-Fi);
   importance/priority/QoS of users or applications using a base station, for the first example base station has 15 gold users and the second base station has two gold users. Thus, the first base station may get more resources on the backhaul to ensure gold user quality of experience is at required level;
   network performance (e.g. core network like PGW, SGW, interfaces between network elements) related to users using a given base station has performance challenges and thus more resources could be assigned to other base stations on the backhaul as long as network performance situation is over related to given base station or users using the base station.
   network element operability status, for example in case LTE base station is broken and unable to operate radio interface it leads to reducing/deactivating backhaul resources related to the base station and sharing the resources among other network elements connected to the shared medium/backhaul.

Secondly, another approach may provide Wi-Fi as one use case. When stand alone Wi-Fi AP is sharing backhaul resources with another 3G, LTE or Wi-Fi or Wi-Fi AP integrated into a small cell base station with 3G and/or LTE module, dividing and allocating backhaul resources may take place according to radio usage and/or meeting user experience for users using the radios. If for example LTE has many (important enough) users Wi-Fi backhaul may get fewer resources, when LTE has fewer users or Wi-Fi has more users (or important users) then Wi-Fi backhaul is allocated more resources.
SSID activation/deactivation is one example where activation of a new SSID (or activation of a Wi-Fi AP as a result of installing new AP or activating the AP to extend radio capacity) leads to dynamic allocation of Wi-Fi backhaul resources for the SSID/AP and also dynamic management of backhaul resources of other 3G, LTE and Wi-Fi using the shared backhaul medium with the Wi-Fi AP where configuration changes occured.
One specific Wi-Fi example either linked to SSID activation or used as a separate feature: User connects to a Wi-Fi hotspot and is authenticated. During authentication AAA server associates the user to a VLAN id (or other id providing reference to resource allocation assigned for the user). After authentication user traffic goes via VLAN tunnel associated to the user. Each VLAN tunnel has then (subset of) QoS characteristics, like bandwidth and/or priority. As a result, e.g. Gold user gets guaranteed QoS (also on the backhaul) when using Wi-Fi, bronze user may get only best effort. In case there are many gold users or gold users use services requiring more resources, resources/bandwidth of the VLAN associated to the Gold users may be increased dynamically or renegotiated to make the Gold VLAN tunnel bigger. This may then lead to readjustment of backhaul resources allocated to other base stations (3G, LTE, Wi-Fi) or RATs sharing the same transport medium.

The suggested solutions may provide in case when one base station covers 3G and/or LTE and/or Wi-Fi, meaning at least two radios, then backhaul resource management related to those radios and technologies may be provided. The approaches may be used in order to activate and deactivate dynamically small cells or stand alone AP Wi-Fi resources. The resource management may be provided upon a need and may be associated with transport and Wi-Fi mechanisms ensuring QoS for selected users.

### BRIEF DESCRIPTION OF THE DRAWINGS

The present invention is illustrated by way of example, and not by way of limitation, in the figures of the accompanying drawings, in which like reference numerals refer to similar elements and in which:

FIG. 1 illustrates user equipment comprising two different policies implemented with two different priorities;

FIG. 2 illustrates a small cells base station before and after configuration with a HRM;

FIG. 3 illustrates an exemplary embodiment of a network, in which resource management may be provided;

FIG. 4 illustrates an exemplary embodiment of a network with an HRM and optionally BRM installed;

FIG. 5 illustrates an exemplary embodiment of a situation before resource management; and

FIG. 6 illustrates the exemplary embodiment of FIG. 5 during a resource management.

### DETAILED DESCRIPTION

Many operators see mobile network as their primary network being able to support QoS, charging, policy control etc. as the operator requires. The Wi-Fi technology is seen as a backup and a way to introduce additional wireless coverage and capacity to complement the mobile network. At present however, the mobile operators do not have tools to dynamically steer on need basis users between mobile and Wi-Fi networks and to dynamically activate Wi-Fi radio and backhaul resources to meet user experience expectations.

The telecommunication standard document 3GPP TS 23.402 ANDSF (release 8) (ANDSF=Access Network Discovery and Selection Function) is suggesting Wi-Fi network selection rules for user devices. However, the suggested mechanisms are not supported by user devices so far. Moreover, ANDSF may not be applicable so far for dynamic online control over user device Wi-Fi network selection.

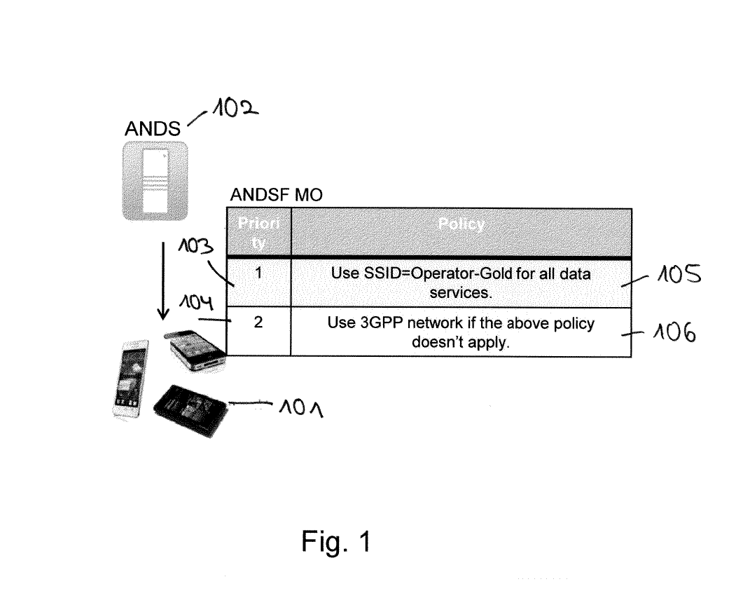

FIG. 1 illustrates several user devices 101, which comprise an ANDSF functionality 102. According to an ANDSF Management Object (MO) example there are provided two different priorities 103, 104 comprising different policies 105, 106. The first priority 103 is provided with the policy 105 that a gold user has a setting of the SSID=Operator-Gold for all data services. The second priority 104 is provided with the policy 106 as an alternative of policy 105 providing a usage of a 3GPP network in the case that the first priority 103 is not applicable. With present technologies a user may select on the user device 101 manually Wi-Fi network for example when bitrates are low in the 3G network. However, manual Wi-Fi network selection takes time and effort and users are often not willing to take the extra effort for selecting. It would be more comfortable for a user to provide mechanisms of selecting an access network with mechanisms, which may work automatically without any manual selection. In addition, when a user controls a network selection manually then an operator has no tools available for offloading traffic from congested mobile cell to for example a Wi-Fi network.

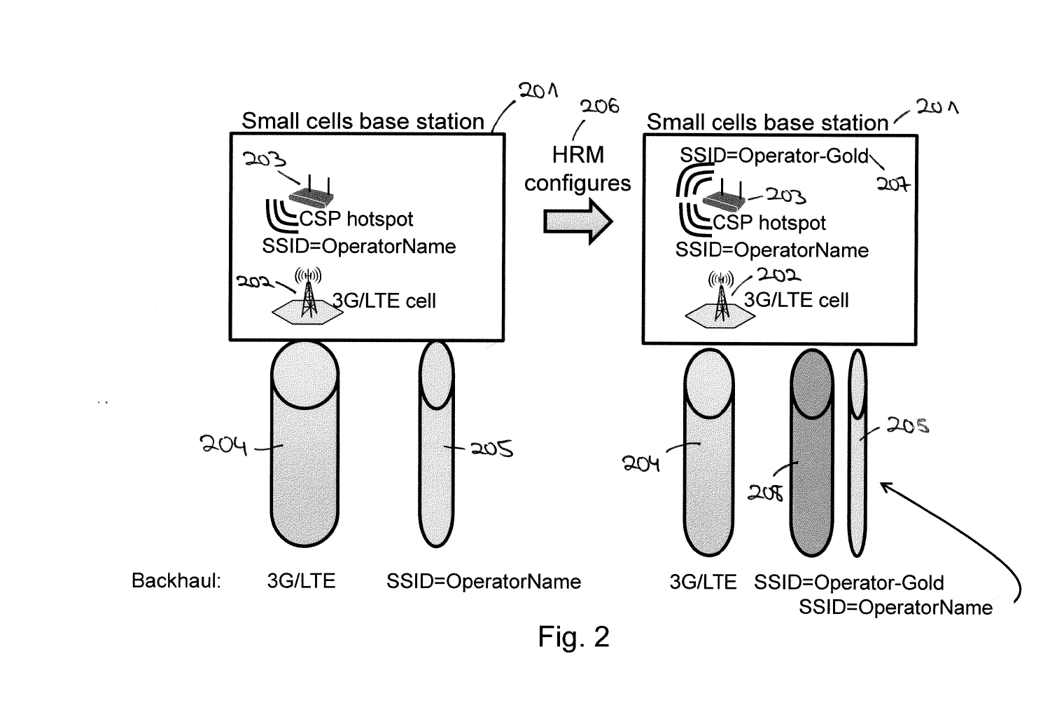

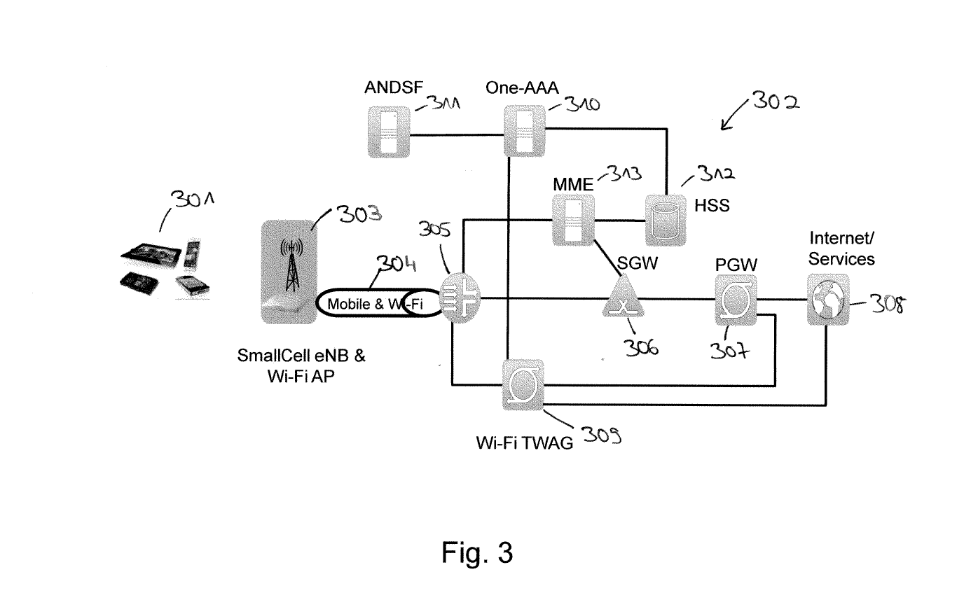

FIG. 2 illustrates a small cells base station before and after configuration by a Hetnet Resource Manager (HRM). FIG. 3 illustrates an exemplary embodiment of a network used for this configuration mechanism.

According to an exemplary embodiment of the present invention there is provided a mechanism for dynamically adjusting both radio and backhaul capacity offered in a small cells base station 201 integrating a 3G and/or LTE cell 202 and a Wi-Fi AP (hotspot) 203 (or integrating 3G and LTE without Wi-Fi AP). In FIG. 2 the first radio technology is provided by the first wireless base station 202 and the second radio technology is provided by a second wireless base station 203, wherein the first wireless base station 202 and the second wireless base station 203 are part of a small cells base station 201. The small cells base station 201 may add or remove Wi-Fi radio resources via SSID usage according to needs. When a SSID is active, UEs identifying the SSID as known may connect and use that. Further, the small cells base station 201 may alter first backhaul resources allocated for 3G/LTE 204 and second backhaul resources allocated for Wi-Fi SSIDs 205 according to a need enabling efficient small cells solution for meeting user experience requirements. In the following an exemplary mechanism with several activities is described.

Implementation of Policies and Configuring These Policies into a UE

An ANDSF 102 (3GPP 23.402 Access Network Discovery or Selection Function), Hotspot 2.0 ANQP (Access Network Query Protocol) or alike network discovery and selection policies are configured into user UE 101 as illustrated in FIG. 1. The policies control where/when/how the UE 101 uses mobile and defined Wi-Fi networks, and which Wi-Fi networks are accepted and approved by the operator. The policies may be configured e.g. when the operator has a new user, when the user has a new UE or when policies change and require update.

In this example SSID=Operator-Gold is configured into the user device 101 and marked as highest priority network to be used when available for IP services. Thus when user uses data service, like browser, the UE 101 connects automatically to SSID=Operator-Gold when available according to the first priority 105.

In this embodiment a SSID is used as an example to refer to Wi-Fi network identifier. Moreover, other IDs, such for example FQDN IDs (Fully Qualified Domain Name) can be used as well, or the ID can simply comprise information about services to be looked for. This may be for example the case if Wi-Fi AP advertizes it supports operator.com service that AP is recommended to be used despite of the SSID of the AP. For example the Hotspot 2.0 technology may allow UEs to identify if the AP provides access to home operator services, which means that it has roaming agreement with the home operator. Then the SSID may not matter but the UE may know it can utilize the AP and the UE has required authentication credentials as well.

In the following exemplary features of a method are described. It may be understood to use one or several features and combine them without departing from the scope of the invention. Moreover, the described features may also be applicable for a network element and a system.

Monitoring Cell Usage

In an example illustrated in FIG. 2 a base station or a RNC or a HRM 206 (Hetnet Resource Manager) monitors a 3G/LTE cell usage 204 in the base station of the small cell 201. By default users are kept in the mobile cell (3G/LTE) 202 since the operator is able to maintain and ensure service level/quality via 3G/LTE QoS and mobility mechanisms.

The HRM functionality is preferably located within eNB, RNC and Wi-Fi AP or part of such a network element. The HRM functionality may also be centralized for the purpose of a “centralized radio resource management”, where one HRM handles resource management related to a number of eNB, RNC, Wi-Fi AP combinations and may be located between a eNB/RNC/Wi-Fi AP and the core network or within the core network.

In the small cell base station 201 the Wi-Fi mechanisms 203 may be deactivated totally by default (in which case UEs may not see the Wi-Fi hotspot at all) or the Wi-Fi mechanisms may have SSID enabled as a default. In case a defined SSID is enabled as default (and the Wi-Fi AP is not totally deactivated), the SSID may have a name not recognized by the operator own selected user UEs which the operator wants to keep in the mobile network by default. For example a gold user UE may not recognize this default SSID but a bronze user UE or visitor UE may recognize and may use the default SSID. A Wi-Fi AP may have e.g. a SSID as a certain name, for example the operator name (SSID=OperatorName) where visitors of the network may buy a daily or monthly pass in order to use the Wi-Fi service of that operator. It should be noted that in this example the SSID=OperatorName is different from the SSID initially configured into the UE 101 during the step of implementing policies and configuring policies into the UE 101.

As an option, operator AAA server authenticating users accessing the hotspot may also be configured by default to deny access from selected users to keep the users in operator mobile network (and away from the SSID).

Detecting a Criteria for Triggering a Backhaul Resource Management

The HRM may detect a predefined condition in the 3G/LTE cell 202, the condition may be e.g. 3G/LTE cell congestion, inability to maintain QoS/user experience for selected user(s) and/or applications, the user uses a certain application (Netflix, P2P, Youtube, etc.), the packet core network reports data or signalling congestion on a packet core interface or on a packet core element (like PGW) to the radio access network, the UE is located on cell edge consuming a high amount of cell capacity unnecessarily or creating interference (handover is preferred) etc.

Also as an exception case HRM may detect that one radio has failed to operate triggering actions defined on subsequent steps.

Managing Backhaul Resources

Managing backhaul resources may be started when the HRM 206 determines e.g. that it cannot handover (enough) UEs 101 to neighboring 3G/LTE cells to manage the cell congestion. Therefore the HRM 206 may activate a new SSID=Operator-Gold 207 in the Wi-Fi AP 203 of the small cells base station 201 to move traffic to the Wi-Fi network. The new SSID 207 can be activated only in the base station's own Wi-Fi AP 203 (in small cell base station integrating 3G/LTE and Wi-Fi), optionally also in the nearby small cells base stations the HRM 206 knows/assumes to be located close enough (to raise probability of traffic offload) and/or in N×nearby Wi-Fi APs that may also be stand alone Wi-Fi APs (e.g. Wi-Fi hotspots covering subway/stadium area where congestion occurs).

In addition, the HRM 206 adjusts small cells base station backhaul to reflect to resource needs. As in the example Gold users are targeted to be offloaded to Wi-Fi 208, and therefore adequate backhaul bandwidth/resource reservation is associated to SSID=Operator-Gold 207. The backhaul bandwidth can be reserved using e.g. a tunnel like VLAN (Virtual LAN). By dedicating enough bandwidth to the Operator-Gold SSID, the HRM 206 ensures that the gold users have good user experience and their services are not affected e.g. by optional visited traffic using OperatorName SSID.

In case the (e)NB and the Wi-Fi AP are in the same base station and sharing the same physical backhaul, moving gold users from 3G/LTE to Wi-Fi means less traffic on 3G/LTE backhaul 204 and thus the bandwidth allocated to 3G/LTE may optionally be reduced by the HRM 206 to be able to assign more bandwidth on the SSID=Operator-Gold 207.

As an option, operator AAA server authenticating users accessing the hotspot may also be configured to allow access from selected users to the hotspot (if access is denied by default).

Further Aspects for Managing Backhaul Resources

As any modern Wi-Fi AP supports 8-64 SSIDs, SSID=Operator-Silver, SSID=Operator-Bronze, SSID=Operator-VIP, SSID=Operator-best-effort etc. may be activated and used as seen feasible. The HRM 206 may execute a procedure deciding how to best optimize resource utilization of the small cells base station.

For example:
Operator strategy may require fulfilling gold user service level prior to considering anything else.
The HRM 206 may detect that there are many silver users (via e.g. QoS negotiations for 3G/LTE use) in the cell and thus moving silver users to Wi-Fi allowed to serve better gold users. Thus the HRM 206 may activate SSID=Operator-Silver instead of SSID=Operator-Gold and silver users having received ANDSF MO earlier prioritize the SSID=Operator-Silver and take that into use automatically. Moreover, Gold users may remain in the 3G/LTE cell 204.
The HRM 206 may also determine deactivation of radio resources of Wi-Fi AP, for example when utilization of 3G or LTE radio has decreased below to a threshold. In this case the HRM 206 may deactivate defined SSID, e.g. SSID=Operator-Gold, to move Gold users from Wi-Fi back to 3G/LTE radio. In addition, the HRM may reduce backhaul resource/bandwidth allocation for Wi-Fi and increase backhaul resource allocation for 3G/LTE.

In summary, these use case examples are showing that radio resources can be activated and deactivated dynamically. It may also be foreseen that 3G or LTE may be activated/deactivated upon need (not only Wi-Fi), for example to save energy during night time, low number of users in LTE that can be served also by 3G etc., and may also relate to dynamic management of backhaul resources.

As the development of mobile cell and Wi-Fi is very fast at present, there may several scenarios become available. In case Wi-Fi becomes the favorite as number one in relation to access point, limited coverage data solution (e.g. with very high bit rates) and as Wi-Fi is already today default UE feature, the HRM 206 might also turn off 3G/LTE cell or reduce service level/capacity available in the 3G/LTE cell in order to allocate more bandwidth for Wi-Fi radio and backhaul. Then as many users as possible may be moved to the Wi-Fi AP 203 of the small cells 201.

For example the HRM 206 may also adjust 3G/LTE resources (like radio) to steer mobile/Wi-Fi usage and serve priority users better. For example in case the operator has only one SSID=OperatorName in Wi-Fi AP 203, and the UEs 101 prioritize Wi-Fi over mobile, when having enough users on the Wi-Fi the HRM 206 might start widening the backhaul bandwidth allocation for Wi-Fi which might result into allocating less bandwidth on the backhaul for the 3G/LTE cell 202

Instead of assigning multiple SSIDs on the Wi-Fi AP radio interface 203, multiple tunnels, like VLANs, may be allocated per Wi-Fi AP 203. Each VLAN ID may be associated e.g. bandwidth and/or other resource like QoS or security characteristics. AP may have e.g. gold, silver, bronze and best effort VLAN IDs and tunnels. During hotspot authentication gold user is associated with VLAN ID for gold-tunnel, silver user with VLAN ID for silver-tunnel etc. Thus each user class/type receives resources according to importance/operator strategy. Resources of each tunnel may be managed according to utilization of each of the VLANs.

As SSID=Operator-Gold 207 has been preconfigured into gold user UEs 101 as highest priority network, the UEs 101 may start moving from 3G/LTE 202 to the Wi-Fi 203 upon detecting the new SSID=Operator-Gold 207. Thus traffic amount on 3G/LTE cell 202 is reduced and overall good quality of service levels may be achieved.

During a Wi-Fi hotspot authentication, the user may be associated to a VLAN ID (or similar). An AAA server/alike element may send VLAN ID assigned to the user during authentication to Wi-Fi AP. This may cause the Wi-Fi AP to associate the user to e.g. gold1-tunnel for which more bandwidth has been allocated than another tunnel (like gold2-tunnel or silver1-tunnel) on the Wi-Fi AP backhaul. VLAN ID may be used as an example and can be similar mechanism as well, depending on used backhaul resource management and tunneling/backhaul technologies.

Users using SSID=OperatorName may experience reduced bitrates as a result of important users using SSID=Operator-Gold with more dedicated bandwidth on Wi-Fi backhaul.

In small cells base station 201 the HRM 206 may coordinate resource utilization over 3G/LTE cell 202 and Wi-Fi AP 203. Therefore the HRM 206 may provide input to Wi-Fi Multimedia (802.11e) prioritizing and scheduling traffic over Wi-Fi radio, Wi-Fi admission control, etc. allowing prioritization of different users and/or different SSIDs. The HRM 206 may have visibility to user profile in 3G/LTE and based on this turn scheduling, admission control, QoS etc. information into QoS and resource allocation information used by the Wi-Fi AP (like 802.1e).

For example allocating more bandwidth to SSID=Operator-Gold may result by default higher bit rates for Gold users as TCP (Transmission Control Protocol) based connection experiences higher rates and lower delays than TCP of user using SSID=OperatorName, where TCP starts limiting traffic. In addition, SSID=Operator-Gold traffic may be prioritized by Wi-Fi AP over SSID=OperatorName using.

If a condition of a triggering criteria no longer applies, the HRM 206 may revert back to cell/Wi-Fi/backhaul resource usage situation that was applied before the triggering criteria occurred. For example the HRM 206 may deactivate SSID=Operator-Gold 207 bringing automatically gold users back to 3G/LTE network 202. Also the HRM 206 may dedicate more backhaul capacity for 3G/LTE cell and SSID=OperatorName as SSID=Operator-Gold 207 is no longer in use.

In a base station with 3G and LTE (and later e.g. any new 3GPP radios), the HRM 206 can utilize 3GPP based technologies to control if UEs utilize 3G or LTE RAT, for example handovers, RAT/Frequency Selection Priority etc. This can be done for example for traffic balancing purposes or according to user subscription (users without LTE subscription are kept in 3G). When the HRM detects for example utilization of 3G or LTE RAT resources changing enough, the HRM may also trigger resource management of the backhauls related to the 3G and LTE RATs. For example increased LTE usage may lead to increased LTE backhaul resources and optionally to decreased 3G backhaul resources. This may cause LTE and 3G scheduling, admission control etc. functionalities also to adjust QoS provided for selected users, for example reduced 3G backhaul resource allocation means renegotiating QoS for users using 3G cell.

In above there was described an example when Wi-Fi AP can be deactivated for example when there is room in 3G/LTE cell. In the same way, small cell base station may for example keep only 3G active and LTE inactive by default to save energy, to avoid interference etc. When 3G radio utilization exceeds a threshold (bitrate, number of users, QoS etc.) LTE radio may be activated. The HRM may reflect this configuration change then also to the backhaul and for example allocate dynamically certain amount of backhaul resources to the LTE RAT that may lead also to reallocation of backhaul resources related to the 3G RAT. In this example Wi-Fi AP may or may not be present in the base station integrating 3G and LTE radios.

The Wi-Fi (or 3G/LTE) radio resource activation may work independently from backhaul tunnel allocation or backhaul resource assignment—and visa versa. The 3G/LTE cell 202 which may reflect a present network is used only as example. Any cell technology may apply, like LTE-Advanced and further generations.

FIG. 3 illustrates an exemplary embodiment for several UEs 301 to access a communication network 302 where multiple Wi-Fi APs, small cell base stations, Femtos, 303 etc. share the same physical backhaul resources 304 at some point and then bandwidth management is needed on the backhaul. This backhaul management may be provided by a network element 305, such as a HRM. The network 302 further comprises a Serving Gateway 306 (SGW), a PGW 307, which is connected to the internet 308. Moreover, the network comprises a Wi-Fi TWAG 309 (Trusted WLAN Access Gateway), a One-AAA 310, an ANDSF 311 connected with the One-AAA 310 and a HSS 312, connected with the One-AAA 310 and with an MME 313. Moreover, the MME 313 is connected with the SGW 306. The HRM 305 is connected directly with the MME 313, with the SGW 306 and with the Wi-Fi TWAG 309.

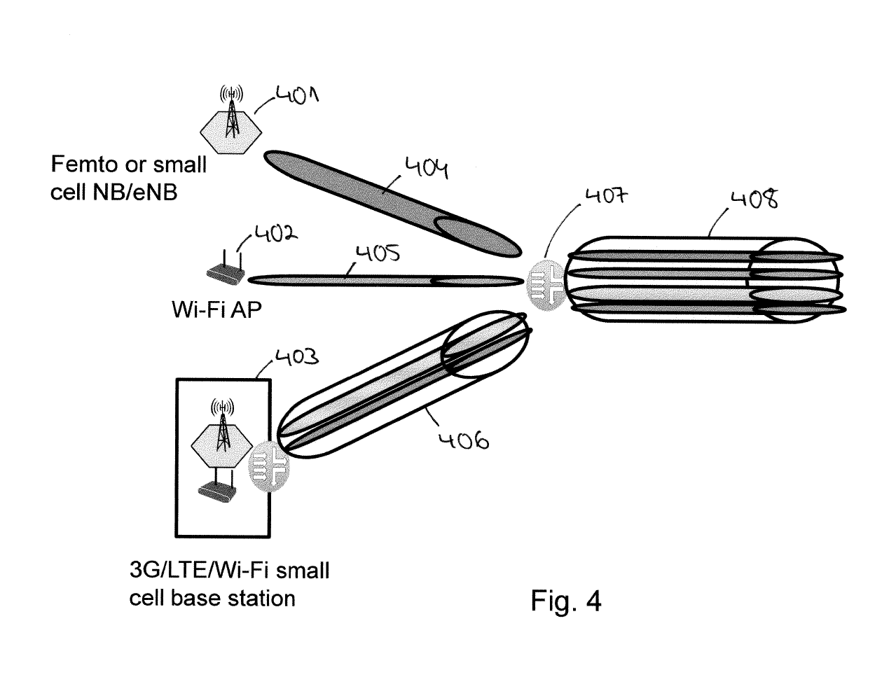

FIG. 4 illustrates a network system comprising a first wireless base station 401, a second wireless base station 402, a third wireless base station 403 and a network element 407 which provides a resource management for three access technologies. In FIG. 4 the first base station 401 is a femto cell or a small cell NB/eNB based on LTE technology. The second base station 402 is provided by a Wi-Fi AP and is based on Wi-Fi technology. The third base station 403 is a 3G/LTE/Wi-Fi small cell base station. The three base stations 401, 402, 403 are using backhaul resources 404, 405, 406, respectively. All backhaul resources 404, 405, 406 are managed in a common control point 407. The common control point (or GW like BNG, BRAS, Security GW etc.) 407 performs backhaul bandwidth/resource management based on the base station or the AP radio utilization or priority/importance of connected users, number of connected users etc. or a combination thereof may be utilized. The common access point 407 may provide an optional backhaul aggregation point depending on a backhaul configuration of the operator of the network. At that location a HRM 407 or a BMR 407 may be installed to control the first and second backhaul resources 404, 405 and the common backhaul resources 408. As an alternative, the HMR 407, may be installed in a base station or an access point of the network and the BMR may be installed at point 407. The network element 407 is in this example a HRM as a single entity, which could also be replaced by a network controller, a network node, an eNB, a server, an RNC or a Wi-Fi access point having the same functionalities as the HRM 407 and being on a different installation point, for example directly installed in a base station. The HRM 407 or a similar network element may be adapted to initiate a managing of the common backhaul resources 408 and may coordinate this management with a BRM. The common backhaul resource 408 is managed according to selectable criteria.

Exemplary embodiments of the present invention are described for a small cells point where an (e)NB and a Wi-Fi AP may be integrated into the same base station. However, further exemplary embodiments of the present invention may also apply to a stand-alone Wi-Fi AP, such as a hotspot.

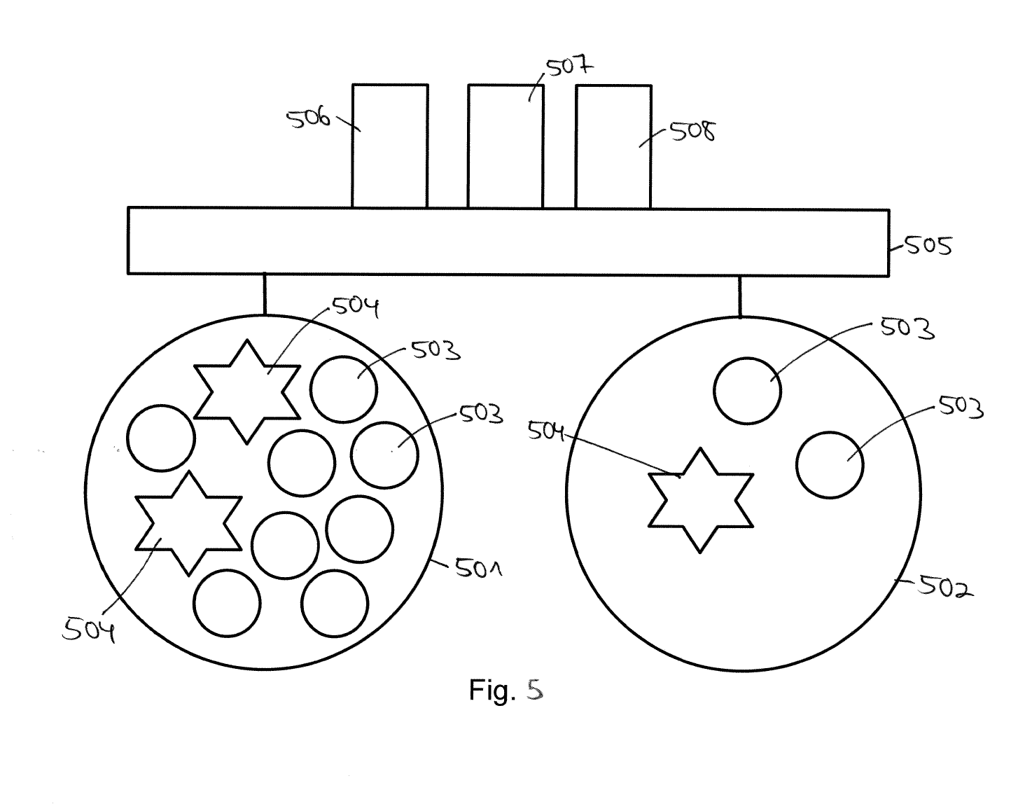

FIG. 5 illustrates a general example how the different users in two different access technologies are allocated according to a backhaul resource management. In FIG. 5 a first access point 501 of an LTE technology and a second access point 502 of a Wi-Fi technology are given. Several users are connected to the first and second access point 501, 502, respectively. There are regular users 503 and gold-users 504 present in both access points 501, 502. The first access point 501 is congested, due to the number of regular users 503, whereas the second access point 502 is not congested.

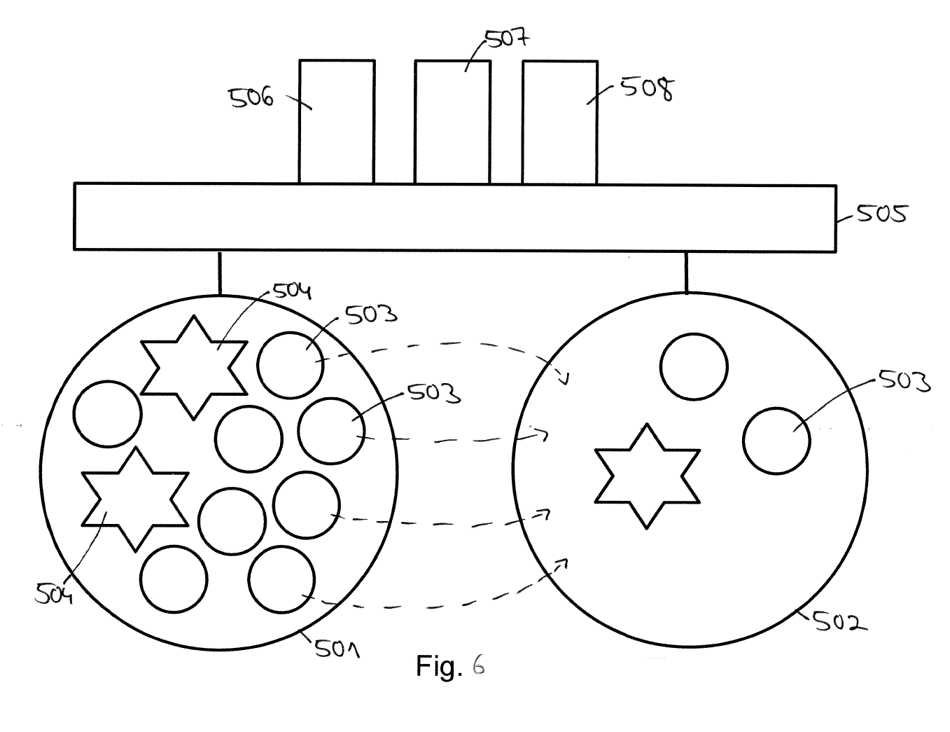

Both access points 501, 502 are sharing a common resource 505 with several backhaul media 506, 507, 508. According to a resource management several regular users 503 are automatic shifted to the second access point 504 although they do not move physically in location and they are not aware of this shifting. FIG. 6 illustrates the situation while shifting several regular users 503 to the second access point 502.

Although the invention is illustrated and described herein as embodied in a system and method for managing resources and user equipment movement driven resource management, it is nevertheless not intended to be limited to only these details shown, as various modifications and structural changes may be made therein without departing from the spirit of the invention and within the scope and range of equivalents of the claims.

There may be provided a computer program product comprising code portions for causing a network element, on which the computer program is executed, to carry out the method according to the invention. Moreover, there may be provided a Computer-readable medium embodying that computer program product.

The network devices or network elements and their functions described herein may be implemented by software, e.g. by the computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

For the purpose of the present invention as described herein above, it should be noted that:
an access technology via which signaling is transferred to and from a network element or node may be any technology by means of which a node can access an access network (e.g. via a base station or generally an access node). Any present or future technology, such as 3G or 4G, LTE, LTE-A, and the like may be used;
usable access networks may be any device, apparatus, unit or means by which a station, entity or other user equipment may connect to and/or utilize services offered by the access network; such services include, among others, data and/or (audio-) visual communication, data download etc.;
a user equipment may be any device, apparatus, unit or means by which a system user or subscriber may experience services from an access network, such as a mobile phone, personal digital assistant PDA, a tablet, or computer;
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

Although described above mainly with respect to methods, procedures, an apparatus and modules thereof, it is to be understood that the present invention also covers a computer program products for implementing such methods or procedures and/or for operating such apparatuses or modules, as well as computer-readable (storage) media for storing such computer program products. The present invention also covers any conceivable combination of method steps and operations described above, and any conceivable combination of nodes, apparatuses and modules described above, as long as the above-described concepts of methodology and structural arrangement are applicable.

Furthermore, the network elements and their functions described herein may be implemented by software, e.g. by a computer program product for a computer, or by hardware. In any case, for executing their respective functions, correspondingly used devices, such as an interworking node or network control element, like an MGCF of an IMS network comprise several means and components (not shown) which are required for control, processing and communication/signaling functionality. Such means may comprise, for example, a processor unit for executing instructions, programs and for processing data, memory means for storing instructions, programs and data, for serving as a work area of the processor and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit (e.g. wired and wireless interface means, an antenna, etc.) and the like.

### LIST OF ABBREVIATIONS

3G 3^{rd} Generation Mobile Communication

3GPP 3^{rd} Generation Partnership Project

ANDSF Access Network Discovery and Selection Function

ANQP Access Network Query Protocol

AP Access Point

BNG Border Network Gateway

BRAS Broadband Remote Access Server

BRM Backhaul Resource Manager

(e)NB evolved Node B

FQDN Fully Qualified Domain Name

Hetnet Heterogeneous network

HRM Hetnet Resource Manager

LTE Long Term Evolution

LTE-A LTE-Advanced

MO Management Object

QoS Quality of Service

RAT Radio Access Technology

RAN Radio Access Network

RRC Radio Resource Control

RNC Radio Network Controller

SSID Service Set Identifier

SWLANC Smart WLAN Connectivity

TCP Transmission Control Protocol

TWAG Trusted WLAN Access Gateway

UE User Equipment

VLAN Virtual LAN

VLAN id Virtual LAN identity

Wi-Fi Wireless Fidelity (WLAN multivendor and interoperability compatibility)

Wi-Fi AP Wireless Fidelity Access Point

WLAN Wireless Local Area Network

1.-15. (canceled)

16. Method for managing backhaul resources, comprising
accessing a radio network via a first radio technology and providing first backhaul resources allocated to the first radio technology;
accessing the radio network via a second radio technology and providing second backhaul resources allocated to the second radio technology, wherein the second radio technology is based on Wi-Fi technology;
sharing the first backhaul resources and the second backhaul resources as common backhaul resources;
detecting a criteria for triggering a backhaul resource management; and
managing the common backhaul resources by adapting the allocation for at least one of the first radio technology or the second radio technology.

17. Method according to claim 16, further comprising
managing the common backhaul resources by adjusting bandwidth within the common backhaul resources.

18. Method according to claim 16, wherein the method further comprises
managing the common backhaul resources by allocating at least one service requested by the first radio technology or by the second radio technology to another radio technology, which radio technology was not accessed initially for that service.

19. Method according to claim 16, wherein the first radio technology is provided by a first wireless base station and the second radio technology is provided by a second wireless base station, wherein the first wireless base station and the second wireless base station are part of a small cells base station.

20. Method according to claim 16, wherein the criteria for triggering a backhaul resource management is at least one criteria selected of the group consisting of a radio technology used as first radio technology, a radio technology used as a second radio technology, a congestion situation, bandwidth required for a radio technology, importance of users using a radio technology, priority of users using a radio technology, Quality of Service associated to users using a radio technology, Quality of Service associated to applications using a radio technology, data indicating quality of a user experience, data indicating network performance, applications used in a radio technology, services used in a radio technology, network element operability status, kind of user category and performance situation of a radio technology.

21. Method according to claim 16, further wherein
managing the common backhaul resources is based at least on a radio usage of a base station, on a kind of base station technology, on an importance of a user, on a priority of users accessing a base station, on quality of service for a user, on quality of service of an application using a base station; on a network performance related to users accessing a base station, on an identity associated to a user, on an identity associated to a service on the backhaul, on a virtual LAN identity, on an SSID activation, an SSID deactivation or on a network element operability status.

22. Network element for managing backhaul resources, comprising:
a processor configured to:
observe accessing a radio network via a first radio technology and observe first backhaul resources allocated to the first radio technology;
observe accessing the radio network via a second radio technology and observe second backhaul resources allocated to the second radio technology, wherein the second radio technology is based on Wi-Fi technology;
observe a sharing of the first backhaul resources and the second backhaul resources as common backhaul resources;
detect a criteria for triggering a backhaul resource management; and
manage the common backhaul resources by adapting the allocation for at least one of the first radio technology or the second radio technology.

23. Network element according to claim 22, wherein the network element is installed in the communication network between the first and second backhaul resources and the common backhaul resources.

24. Network element according to claim 22, wherein the network element is a network controller, a network node, an eNB, a server, an RNC, a Wi-Fi access point, a Broadband Remote Access Server, a Border Network Gateway, a Security gateway, a Backhaul Resource Manager or a separate Hetnet Resource Manager entity.

25. Network element according to claim 22, wherein the first radio technology is provided by a first wireless base station and the second radio technology is provided by a second wireless base station, wherein the first wireless base station and the second wireless base station are part of a small cells base station.

26. Network element according to claim 22, wherein the network element is adapted to initiate a managing of the common backhaul resources.

27. Network element according to claim 22, wherein the processor is further configured to manage the common backhaul resources by adjusting bandwidth within the common backhaul resources.

28. Network element according to claim 22, wherein the processor is further configured to manage the common backhaul resources by allocating at least one service requested by the first radio technology or by the second radio technology to another radio technology, which radio technology was not accessed initially for that service.

29. Network element according to claim 22, wherein the first radio technology is provided by a first wireless base station and the second radio technology is provided by a second wireless base station, and wherein the first wireless base station and the second wireless base station are part of a small cells base station.

30. Network element according to claim 22, wherein the criteria for triggering a backhaul resource management is at least one criteria selected of the group including a radio technology used as first radio technology, a radio technology used as a second radio technology, a congestion situation, bandwidth required for a radio technology, importance of users using a radio technology, priority of users using a radio technology, Quality of Service associated to users using a radio technology, Quality of Service associated to applications using a radio technology, data indicating quality of a user experience, data indicating network performance, applications used in a radio technology, services used in a radio technology, network element operability status, kind of user category and performance situation of a radio technology.

31. Network element according to claim 22, wherein managing the common backhaul resources is based on at least one of: a radio usage of a base station, a kind of base station technology, an importance of a user, a priority of users accessing a base station, quality of service for a user, quality of service of an application using a base station; a network performance related to users accessing a base station, an identity associated to a user, an identity associated to a service on the backhaul, a virtual LAN identity, an SSID activation, an SSID deactivation, and a network element operability status.

32. Computer program product embodied on a non-transitory computer-readable medium, said product comprising code portions for causing a network element, on which the computer program is executed, to carry out the method according to claim 16.
